(19) United States
(12) Patent Application Publication
(10) Pub. No.: US 2016/0087254 A1
(43) Pub. Date: Mar. 24, 2016

(54) BATTERY CUFF

(71) Applicant: Gerald J. Lorino, Manahawkin, NJ (US)

(72) Inventor: Gerald J. Lorino, Manahawkin, NJ (US)

(21) Appl. No.: 14/491,694

(22) Filed: Sep. 19, 2014

(51) Int. Cl. H01M 2/10

(52) U.S. Cl. CPC H01M 2/1005

(57) ABSTRACT

An assembly for easily inserting, removing and carrying a motorcycle battery. The assembly comprises a ligature disposed about a motorcycle battery. Engaged with the ligature is an upper member that can be used to carry and guide the motorcycle battery. A pull member, or multiple pull members, can be engaged with the assembly for efficiently guiding the battery once the assembly is engaged thereto, such as in inserting or removing the battery from a battery compartment, and in carrying the battery. A support member can be used in combination with a ligature.

### BACKGROUND

A motorcycle battery must store enough physical energy to start a power-hungry engine at a moment's notice. However, it also must be of a size modest enough to fit in the confined space of a sleek motorcycle body. As a result, a motorcycle battery tends to be a heavy item that must be slipped into and out of a confined area. Installing and removing a motorcycle battery is a process that can be time-consuming, cumbersome and has the potential of damaging the housing containing the battery, and a process that can also make its mark on fingers and feet of motorcycle mechanics and enthusiasts.

### BRIEF DESCRIPTION OF DRAWINGS

FIG. 1 illustrates a perspective view of an example battery cuff in accord with various embodiments.

FIG. 2 illustrates a perspective view of an example battery cuff, engaged with an example battery, in accord with various embodiments.

FIG. 3 illustrates a perspective view of an example battery cuff, and example pull member, in accord with various embodiments.

FIG. 4 illustrates a side view of an example battery cuff, and example multiple pull members, in accord with various embodiments.

FIG. 5 illustrates a perspective view of an example battery cuff, and support member, in accord with various embodiments.

FIG. 6 illustrates a perspective view of an example battery cuff, and support member, engaged with an example battery, in accord with various embodiments.

### DETAILED DESCRIPTION

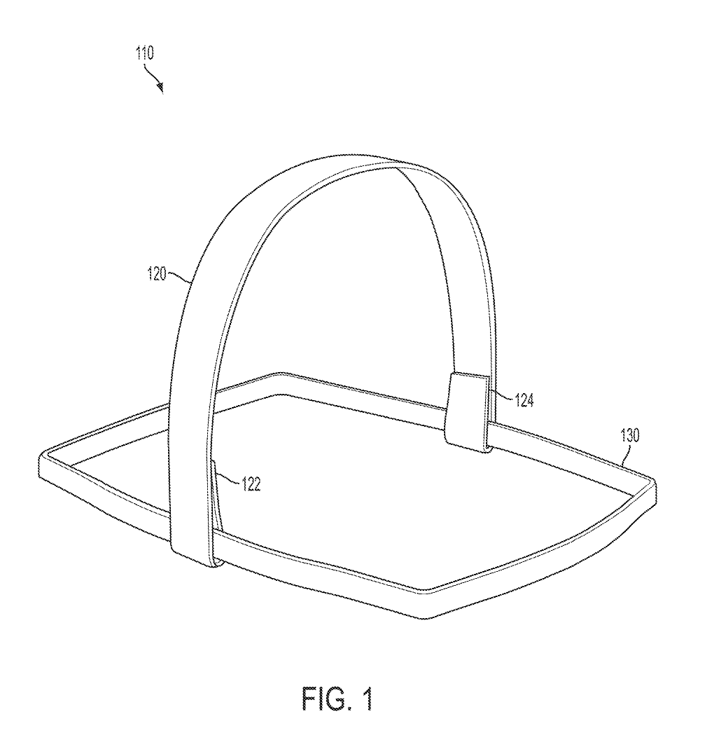

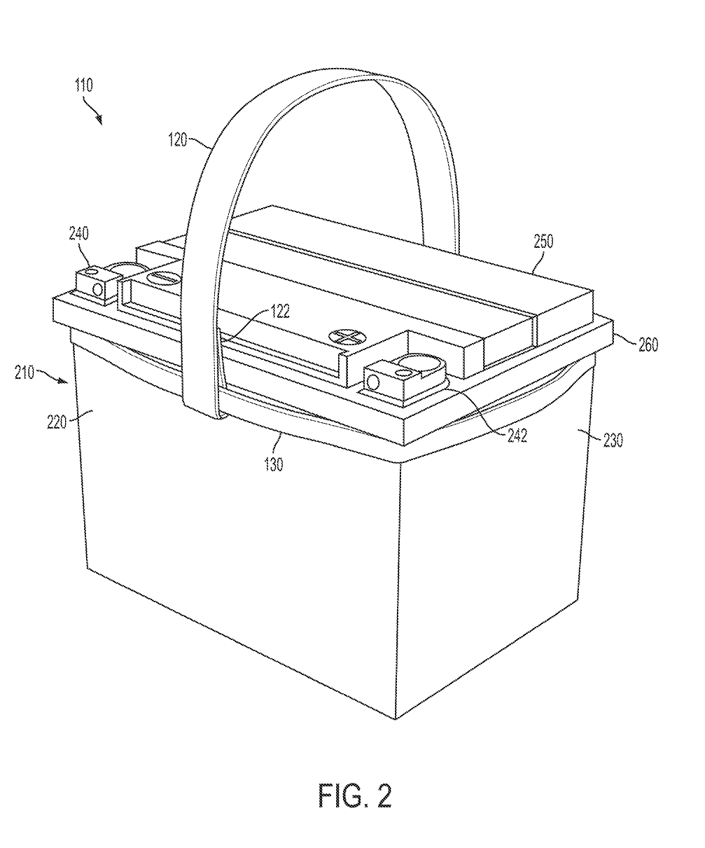

FIG. 1 depicts an example motorcycle battery cuff 110. In an embodiment, battery cuff 110 can include an upper member 120. Upper member 120 can assist with lifting and carrying a battery 210 engaged with battery cuff 110. (An illustration of an example battery 210 engaged with battery cuff 110 can be seen in FIG. 2). Upper member 120 can comprise material such as a synthetic polymer, natural material, combination of the two, or any other material suitable for engaging a battery 210. Upper member 120 can comprise a single strip of material secured at junction 122 and junction 124 with ligature 130. Upper member 120 can comprise two or more connected strips of material. The securing can be accomplished by forming a loop of material comprising one end of upper member folded back on itself and then stitched or fastened by another mechanism at a junction. The material of upper member 120 can be substantially flexible (such that it can, among other things, be tucked next to the battery 210 during operation) but must be strong enough, in conjunction with the rest of the structures, to handle the weight of a battery.

Upper member 120 can have a portion on which a grip member (not shown) can be disposed. The grip member can comprise a structure placed on and/or around upper member 120 which can enhance ability to lift, carry, or otherwise manipulate a battery 210.

Upper member 120 can be in engagement with ligature 130. In an added embodiment, one or both of proximal and distal ends of upper member 120 (here shown in the area of junctions 122, 124 respectively) can be attached to and detached from ligature 130 with a mechanism therefore.

Ligature 130 can be disposed about the sides of battery 210 such that ligature 130 forms a closed connection upon itself. Ligature 130 can be formed of a durable polymeric substance or another substance that can support the weight of a battery 210 and engage with battery 210. Ligature 130 can be integrally formed and slipped onto the battery from the base toward top casing 250. Alternatively, ligature 130 can be a strip of material that is engaged with battery 210, and the two ends of the material can be secured one to the other. Such securing can be done by bonding, as by a knot, cable tie, or other mechanism. In additional embodiments securing can be done by engaging one or both ends of ligature 130 to a structure on the battery.

In an embodiment, ligature 130 can be positioned in contact with or closely adjacent to lip 260. Lip 260 can be found proximal to the top casing of battery models. So positioned, ligature 130 can help form a load-bearing mechanism that, with upper member 120, can assist in inserting, removing and carrying battery 210.

Upper member 120 can be configured so junctions 122, 124 are substantially opposite each other, relative to the position of the battery, for adequate carrying capacity and load-bearing. Alternatively, one junction only may be used between upper member 120 and ligature 130.

Ligature 130 can be placed at a position not closely adjacent to lip 260. In this embodiment, ligature 130 grasps battery 210 firmly.

FIG. 2 depicts an example battery 210 used in conjunction with an embodiment of battery cuff 110. The battery casing can include a side casing 220 and side casing 230 (and other side casings, not shown). There can be a top casing 250 (and bottom casing, not shown). There can be a terminal 240 and terminal 242. Battery cuff 110 can supportably engage relevant portions of side casing 220 and side casing 230 (and other side casings not shown), and/or lip 260. Battery cuff 110 can leave open, and not interfere with, top casing 250 including terminals 240, 242.

Battery cuff 110 engaging battery 210 can be slipped into the motorcycle body battery compartment (not shown) in which the battery is housed during normal motorcycle operation.

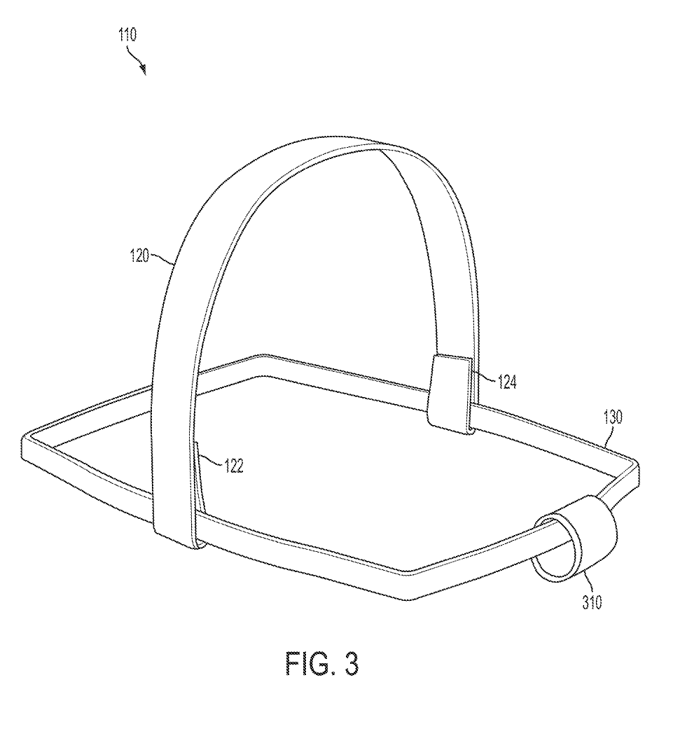

FIG. 3 depicts an embodiment of a battery cuff 110 that includes a pull member 310. Pull member 310 can have a generally loop-shaped configuration. Pull member 310 can be integrally formed, or can be formed from one strip of material or multiple strips. Also, pull member 310 can be secured to ligature 130 such that battery cuff 110 can be pulled or guided. Pull member can be immovably fastened to ligature 130. The fastening may be done by stitching or other mechanism. Alternatively, pull member may comprise a moveable loop that can slide along ligature 130.

A motorcycle battery is typically housed in a compartment that is a top-replace or side-replace. With a top-replace, in general the seat can be removed for access to the battery compartment. Then the battery can be lifted upwards and away from the motorcycle. With a side-replace, the compartment can be accessible from the side of the motorcycle. The battery can then be slid laterally out of the motorcycle. Pull member 310 can be used for both top-replace and side-replace compartments. Pull member 310 can assist with the close navigation and control associated with top replacement of a battery. Pull member 310 can also assist in lateral removal of a battery from the battery compartment, where the battery compartment is accessible from the side of the motorcycle frame or body. Accordingly, pull member 310 can be used to guide and/or support battery cuff 110 during insertion or removal of battery cuff 110 from the battery compartment of a motorcycle. Pull member 310 can also be used in carrying and other handling of the battery cuff 110, into which a battery 210 has been inserted, outside a motorcycle.

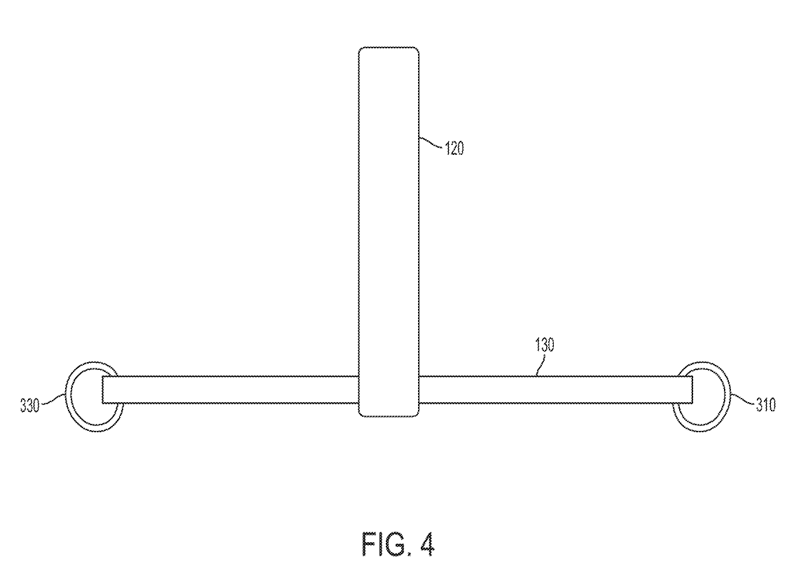

As seen in FIG. 4, multiple pull members may be used. For example, pull member 310 may be positioned engaging ligature 130, and pull member 330 may also be positioned engaging ligature 130. Multiple pull members can even further enhance versatility by enabling the battery to be pulled out by either or both of pull member 310 and/or pull member 330.

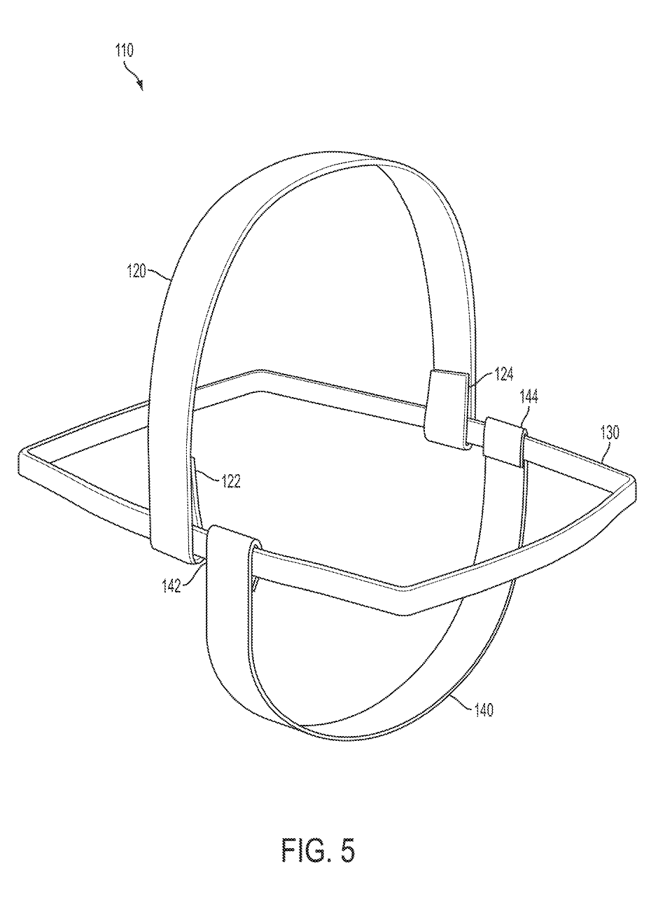

FIG. 5 illustrates an example of a battery cuff 110 further comprising a support member 140. Support member 140 can be used in combination with ligature 130 further to enhance support and navigational efficiency. Support member 140 can comprise material such as a synthetic polymer, natural material, combination of the two, or any other material suitable for engaging a battery 210. Support member 140 can comprise a single strip of material secured at junction 142 and junction 144 with ligature 130. Support member 140 can comprise two or more connected strips of material. The securing can be accomplished by forming a loop of material comprising one end of support member 140 folded back on itself and then stitched or fastened by another mechanism at a junction. The material of support member 140 can be substantially flexible (such that it can, among other things, be tucked next to the battery 210 during operation) but must be strong enough, in conjunction with the rest of the structures, to handle the weight of a battery. Support member 140 can also engage with upper member 120.

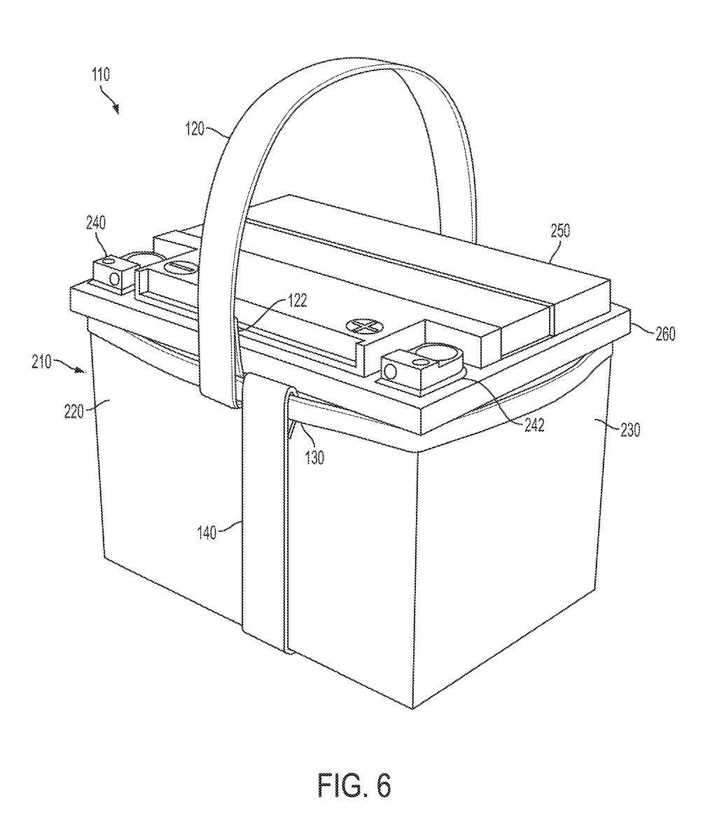

FIG. 6 depicts an example battery 210 used in conjunction with an embodiment of battery cuff 110, and support member 140. The battery casing can include a side casing 220 and side casing 230 (and other side casings, not shown). There can be a top casing 250 (and bottom casing, not shown). There can be a terminal 240 and terminal 242. Battery cuff 110 can supportably engage relevant portions of side casing 220 and side casing 230 (and other side casings not shown), and/or lip 260. Battery cuff 110 can leave open, and not interfere with, top casing 250 including terminals 240, 242. Support member 140 can aid in supporting battery 210.

The disclosures herein relate to a motorcycle battery. However, the disclosures herein can also be applied to a battery of another vehicle or device requiring a battery, such as but not limited to an automobile, boat, jet ski, snowmobile, lawnmower, recreational vehicle, all-terrain vehicle, or construction equipment.

In the description hereof, reference is made to the accompanying drawings which illustrate several embodiments of the present invention. It is understood that other embodiments may be utilized, and mechanical, compositional, structural, and other operational changes may be made without departing from the spirit and scope of the present disclosure. The following detailed description is not to be taken in a limiting sense, and the scope of the embodiments of the present invention is defined only by the claims of the issued patent.

While the invention has been described in terms of particular embodiments and illustrative figures, those of ordinary skill in the art will recognize that the invention is not limited to the embodiments or figures described.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, those skilled in the art will appreciate that the structures for securing described herein (e.g., forming the junctions) may be replaced or supplemented by other suitable securing means including a variety of other types of mechanical securing devices (e.g., nails, rivets, or others). In another example, a particular choice of construction material (e.g., polymeric, etc.) may be replaced or supplemented by another type of material which is suitable for the same or similar structure or function.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

It will be appreciated that, for convenience and clarity of disclosure, terms describing relative orientation or spatial positioning such as “vertical,” “horizontal,” “up,” “down,” “top,” “front,” “back,” or “bottom,” may be used at times herein with respect to the drawings and text description in association with various embodiments of the invention. However, such terms are primarily used for illustrative purposes and are not necessarily intended to be limiting in nature.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art. For example, there may be variations to these diagrams or the operations described herein without departing from the spirit of the invention.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

While the invention has been described in terms of particular embodiments and illustrative figures, those of ordinary skill in the art will recognize that the invention is not limited to the embodiments or figures described.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An assembly for engaging a battery, comprising:
a ligature structured for disposal around upper portions of a casing of a battery; and
an upper member, wherein the ends of the upper member engage with at least two substantially opposite portions of the ligature.

2. The assembly of claim 1, wherein the ligature is disposed adjacent to and below a lip of the battery.

3. The assembly of claim 1, further comprising a grip member engaging the upper member.

4. The assembly of claim 1, further comprising a pull member, the pull member engaging the ligature or the upper member.

5. The assembly of claim 4, wherein the pull member is substantially in the shape of a loop.

6. The assembly of claim 4, wherein the pull member is positionally fixed on the ligature or upper member.

7. The assembly of claim 4, wherein the pull member is slideably moveable along the ligature or upper member.

8. The assembly of claim 1, further comprising two or more pull members, the two or more pull members engaging one or both of the upper member or the ligature.

9. An assembly for engaging a battery, comprising:
ligature means disposed below a lip of a battery; and
handle means in contact with ligature means, wherein the handle means are in contact with at least two substantially opposite portions of the ligature means.

10. The assembly of claim 9, further comprising a grip member engaging the handle means.

11. The assembly of claim 9, further comprising a pull member in contact with the handle means or the ligature means.

12. The assembly of claim 11, wherein the pull member is substantially in the shape of a loop.

13. The assembly of claim 11, wherein the pull member is positionally fixed on the ligature means or handle means.

14. The assembly of claim 11, wherein the pull member is slideably moveable along the ligature means or handle means.

15. The assembly of claim 9, further comprising two or more pull members in contact with the ligature means or handle means.

16. An assembly for engaging a battery, comprising:
a ligature structured for disposal around upper portions of a casing of a battery;
an upper member, wherein the ends of the upper member engage with at least two substantially opposite portions of the ligature; and
a support member engaged with at least two portions of the ligature.

17. The assembly of claim 16, wherein the ligature is disposed adjacent to and below a lip of the battery.

18. The assembly of claim 16, further comprising a grip member engaging the upper member.

19. The assembly of claim 16, further comprising a pull member, the pull member engaging the ligature or the upper member.

20. The assembly of claim 19, wherein the pull member is substantially in the shape of a loop.
